(19) United States
(12) Patent Application Publication
(10) Pub. No.: US 2004/0181662 A1
(43) Pub. Date: Sep. 16, 2004

(54) Information processing system, information processing apparatusand method, and program

(76) Inventors: Shinichi Kanai, Saitama (JP); Tsunetake Noma, Tokyo (JP); Masataro Yamaguchi, Tokyo (JP); Atsushi Fuse, Tokyo (JP); Takamasa Iwade, Tokyo (JP); Kou Fujiwara, Tokyo (JP); Hiroyuki Moriya, Tokyo (JP); Kazushi Yoshida, Tokyo (JP)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 10/650,281

(22) Filed: Aug. 28, 2003

(30) Foreign Application Priority Data
Sep. 6, 2002 (JP) P2002-261156
Sep. 6, 2002 (JP) P2002-261157

(51) Int. Cl. H04L 9/00

(52) U.S. Cl. 713/155

(57) ABSTRACT

This invention is intended to build a system with service cores integrated. A user terminal sends authentication information and area information to an image service providing server via a network. The image service providing server receives the authentication information and the area information from the user terminal, selects an authentication server of an area corresponding to the area information from among authentication servers of all areas, and sends the authentication information received from the user terminal to the selected authentication server via the network. The authentication server receives the authentication information of the user terminal from the image service providing server and executes the authentication of the user terminal on the basis of the received authentication information. The present invention is applicable to image service providing systems which provide image-based services.

### BACKGROUND OF THE INVENTION

The present invention relates generally to an information processing system, an information processing apparatus and method, and a program and, more particularly, to an information processing system, an information processing apparatus and method, and a program that mitigate the load of servers while integrating the core of services, thereby significantly decreasing the management cost.

Recently, various kinds of content have come to be provided through networks. To cope with this situation, some information providing systems have been proposed in which one control server executes communication, control, or user management for a plurality of added value service servers installed in a network and the access from this control server to user terminals and vice versa are executed via a gateway which provides an interface integrated for the user terminals (refer to Japanese Patent Laid-open No. 2001-142798 for example).

However, in the above-mentioned related-art information providing system, only one control server controls a plurality of added value service servers, thereby increasing the load of control server too much for controlling the access operations of the user terminals in the entire area.

On the other hand, in order to suppress the above-mentioned load, if a related-art information providing system configured by a plurality of added value service server, control servers, and gateway servers is installed in each area, thereby controlling only the access to the added value service server from user terminals in a particular area, the core of added value services is distributed over a plurality of areas, resulting in such different added value service levels for different service areas as a timing lag in starting new services for example.

Another problem with the above-mentioned related-art information providing system is that the information providing system must be operated in each area, thereby increasing the management cost or operational cost.

### SUMMARY OF THE INVENTION

It is therefore an object of the present invention to provide an information processing system, an information processing apparatus and method, and a program intended to mitigate the load of servers while integrating the cores of services, thereby significantly decreasing the management cost.

According to the first aspect of the present invention, there is provided an information processing system including:

a first information processing apparatus;

a second information processing apparatus, installed in each of areas, for authenticating the first information processing apparatus in a target area; and

a third information processing apparatus for providing content to the first information processing apparatus;

the first information apparatus, the second information apparatus, and the third information processing apparatus being interconnected via a network;

wherein the first information processing apparatus sends authentication information for authenticating a user and preset area information to the third information processing apparatus via the network;

the third information processing apparatus selects the second information processing apparatus corresponding to the area information obtained from the first information processing apparatus and sends the authentication information obtained from the first information processing apparatus to the selected second information processing apparatus via the network; and

the second information processing apparatus authenticates the first information processing apparatus on the basis of the authentication information received from the third information processing apparatus and sends authentication result information for the first information processing apparatus to the third information processing apparatus via the network.

According to the second aspect of the present invention, there is provided an information processing apparatus including:

acquiring means for acquiring authentication information for authenticating a user of first another information processing apparatus and preset area information from the first another information processing apparatus;

selecting means for selecting second another information processing apparatus corresponding to the area information acquired by the acquiring means;

sending means for sending, via the network, the authentication information of the first another information processing apparatus acquired by the acquiring means to the second another information processing apparatus selected by the selecting means; and

receiving means for receiving, via the network, authentication result information for the first another information processing apparatus from the second another information processing apparatus.

According to the third aspect of the present invention, there is provided an information processing method for an information processing apparatus for providing content, including the steps of:

acquiring authentication information for authenticating a user of first another information processing apparatus and preset area information from the first another information processing apparatus;

selecting second another information processing apparatus corresponding to the area information acquired by the acquiring step;

sending, via the network, the authentication information of the first another information processing apparatus acquired by the acquiring step to the second another information processing apparatus selected by the selecting step; and

receiving, via the network, authentication result information for the first another information processing apparatus from the second another information processing apparatus.

According to the fourth aspect of the present invention, there is provided an information processing apparatus including:

receiving means for receiving, via a network, authentication information for authenticating a user of first another information processing apparatus from second another information processing apparatus;

authenticating means for authenticating the first another information processing apparatus on the basis of the authentication information received by the receiving means; and

sending means for sending, via the network, authentication result information for the first another information processing apparatus obtained by the authenticating means to the second another information processing apparatus.

According to the fifth aspect of the present invention, there is provided an information processing method for an information processing apparatus installed in each area, including the steps of:

receiving, via a network, authentication information for authenticating a user of first another information processing apparatus from second another information processing apparatus;

authenticating the first another information processing apparatus on the basis of the authentication information received by the receiving step; and

sending, via the network, authentication result information for the first another information processing apparatus obtained by the authenticating step to the second another information processing apparatus.

According to the sixth aspect of the present invention, there is provided an information processing apparatus including:

memory area control means for controlling the creation of a memory area corresponding to first another information processing apparatus accessed via a network;

storage means for receiving a content ID from the first another information processing apparatus and storing the content ID into the memory area whose creation has been controlled by the memory area control means;

issuing means for issuing a memory area ID of the memory area in which the content ID is stored and authentication permission information indicative of the authentication of the first another information processing apparatus;

selecting means for selecting second another information processing apparatus corresponding to the first another information processing apparatus on the basis of area information of the first another information processing apparatus; and

sending means for sending, via the network, the memory area ID and the authentication permission information issued by the issuing means to the first another information processing apparatus along with URL information of the second another information processing apparatus selected by the selecting means.

According to the seventh aspect of the present invention, there is provided an information processing method including the steps of:

controlling the creation of a memory area corresponding to first another information processing apparatus accessed via a network;

receiving a content ID from the first another information processing apparatus and storing the content ID into the memory area whose creation has been controlled by the memory area control step;

issuing a memory area ID of the memory area in which the content ID sent from the first another information processing apparatus is stored and authentication permission information indicative of the authentication of the first another information processing apparatus;

selecting second another information processing apparatus corresponding to the first another information processing apparatus on the basis of area information of the first another information processing apparatus; and

sending, via the network, the memory area ID and the authentication permission information issued by the issuing step to the first another information processing apparatus along with URL information of the second another information processing apparatus selected by the selecting step.

According to the eighth aspect of the present invention, there is provided an information processing apparatus including:

receiving means for receiving, from first another information processing apparatus, via a network, a memory area ID corresponding to the first another information processing apparatus in second another information processing apparatus and authentication permission information indicative of being authenticated by the second another information processing apparatus;

acquiring means for acquiring, on the basis of the memory area ID and the authentication permission information received by the receiving means, a content ID stored in a memory area corresponding to the memory area ID and content information corresponding to the content ID from the second another information processing apparatus via the network; and

sending means for sending the content information acquired by the acquiring means to the first another information processing apparatus.

A network as used herein denotes a mechanism in which at least two devices are interconnected to transmit information from one device to another. The devices communicating each other may be standalone devices or internal blocks which constitute one device.

### BRIEF DESCRIPTION OF THE DRAWINGS

These and other objects of the invention will be seen by reference to the description, taken in connection with the accompanying drawing, in which:

FIG. 1 is a schematic diagram illustrating an exemplary configuration of an image service providing system practiced as one embodiment of the invention;

FIG. 2 is a schematic diagram illustrating a detail exemplary configuration of the image service providing system shown in FIG. 1;

FIG. 3 is a block diagram illustrating an exemplary configuration of a user terminal shown in FIG. 2;

FIG. 4 is a block diagram illustrating an exemplary configuration of the image service providing server shown in FIG. 2;

FIG. 5 is a block diagram illustrating an exemplary functional configuration in the case in which user authentication processing is executed by the image service providing system shown in FIG. 2;

FIG. 6 is a flowchart describing the user authentication processing by the image service providing system shown in FIG. 5;

FIG. 7 shows an exemplary configuration of user authentication information;

FIG. 8 is a flowchart describing the user registration processing by the above-mentioned image service providing system shown in FIG. 5;

FIG. 9 is a flowchart describing the user information change processing by the above-mentioned image service providing system shown in FIG. 5;

FIG. 10 is a block diagram illustrating an exemplary functional configuration in the case in which service providing processing is executed by the image service providing system shown in FIG. 2;

FIG. 11 is a flowchart describing service providing processing by the image service providing server shown in FIG. 10;

FIG. 12 is a flowchart describing the communication processing by a user terminal shown in FIG. 10;

FIG. 13 is a flowchart describing the processing of communication with a sale server in step S227 shown in FIG. 12;

FIG. 14 is a flowchart describing the service providing processing by the sale server shown in FIG. 10;

FIG. 15 is a flowchart describing content information acquisition processing in step S254 shown in FIG. 14;

FIG. 16 is a flowchart describing the content information transmission processing by the image service providing server shown in FIG. 10;

FIG. 17 shows an exemplary configuration of an image select screen of the image service providing server shown in FIG. 10;

FIG. 18 shows an exemplary configuration of a cart confirmation screen of the sale server shown in FIG. 10;

FIG. 19 shows an exemplary configuration of the information in a cart area; and

FIG. 20 shows an exemplary configuration of content information.

### DETAILED DESCRIPTION OF THE PREFERRED EMBODIMENTS

This invention will be described in further detail by way of example with reference to the accompanying drawings.

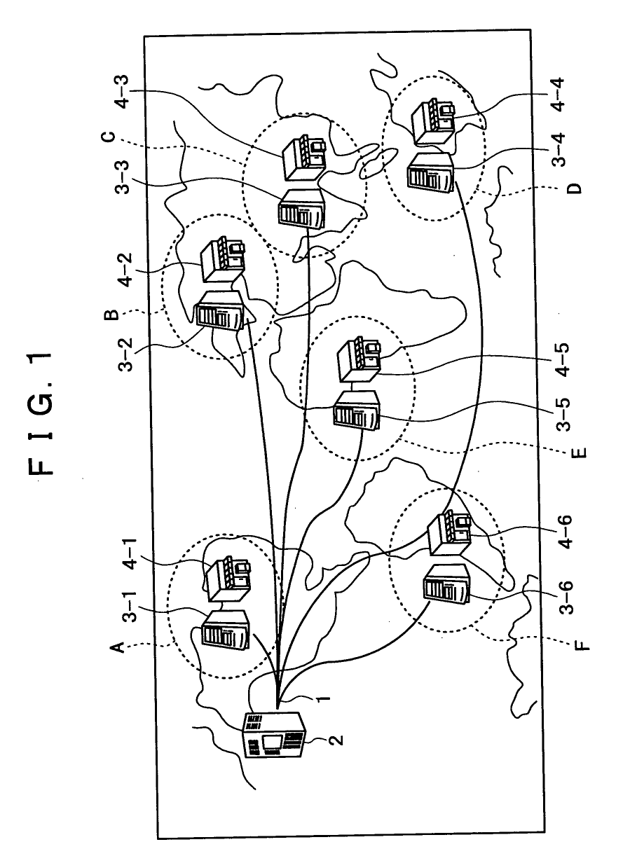

Now referring to FIG. 1, there is shown an exemplary configuration of an image service providing system to which the present invention is applied. In the example shown in FIG. 1, an authentication server 3-1 and a sale server 4-1 are arranged in area A, an authentication server 3-2 and a sale server 4-2 in area B, and an authentication server 3-3 and a sale server 4-3 in area C. An authentication server 3-4 and a sale server 4-4 are arranged in area D, an authentication server 3-5 and a sale server 4-5 in area E, and an authentication server 3-6 and a sale server 4-6 in area F. Thus, an authentication server 3 and a sale server 4 are arranged in each area. These authentication servers and sale servers are connected to one image service providing server 2 via a network 1 typified by the Internet. It should be noted that the authentication servers 3-1 through 3-6 and the sale server 4-1 through 4-6 are generically referred to as the authentication server 3 and the sale server 4 unless otherwise specified.

The image service providing server 2 is constituted by one unit regardless of area and language and manages content such as images, providing the services based on this content to the users of all areas.

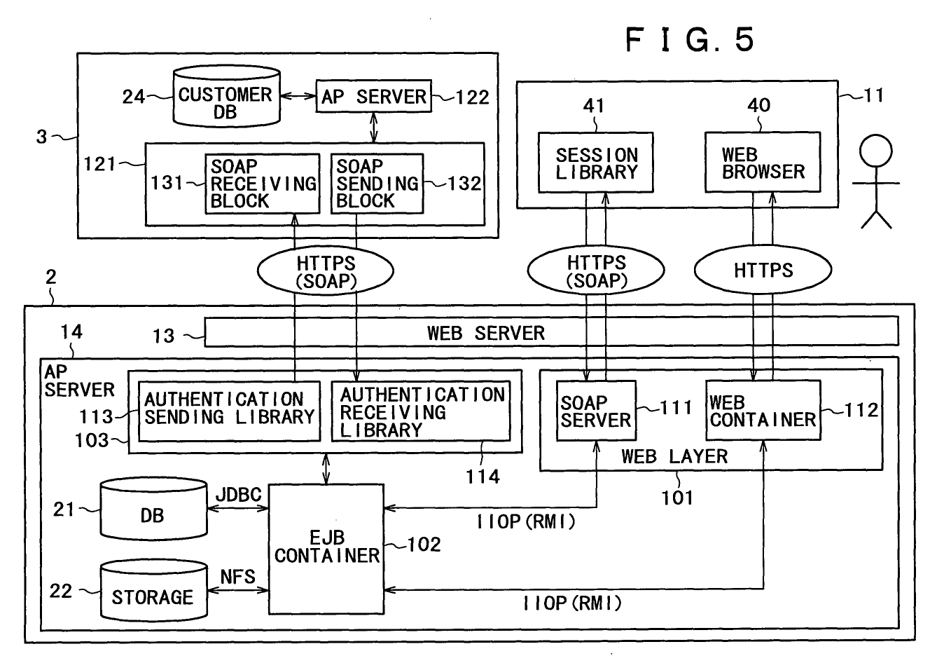

The authentication server 3 arranged in each area manages the common user information used by a plurality of network services (including the image service providing system) in that area to execute the authentication of users who use these network services. Namely, the authentication server 3 is used for the authentication of the user information for not only image service providing system but also other network services. An interface (SOAP server 121 shown in FIG. 5) of the authentication server 3 is common to the authentication servers 3 of all areas and the connection from the image service providing server 2 to the authentication server 3 is made through a same library (authentication library 103 shown in FIG. 5).

As with the authentication server 3, the sale server 4 installed in each area gets the content (for example, images) managed by the image service providing server 2 and provides sale services based on the obtained content (for example, print service, bookbinding service, and print service for printing images to T-shirts and tableware, for example) to the users of each area covered by the sale server 4. In addition, the sale server 4 in each area provides the electronic settlement capabilities corresponding to these sale services. It should be noted that the sale server 4 may be dedicated to the image service providing system or shared by another network service. Alternatively, the sale server 4 may be a server for another business partner.

It should also be noted that, in the example of FIG. 1, there are only 6 units of the authentication server 3 and the sale server 4; one unit of the authentication server 3 and one unit of sale server 4 are installed in each preset area. Therefore, the preset number of authentication servers 3 and sale servers 4 are connected to the network 1. In this example, each area managed by the authentication server 3 and the sale server 4 is the same area for the convenience of description; it will be apparent that different areas may be managed by the authentication server 3 and the sale server 4.

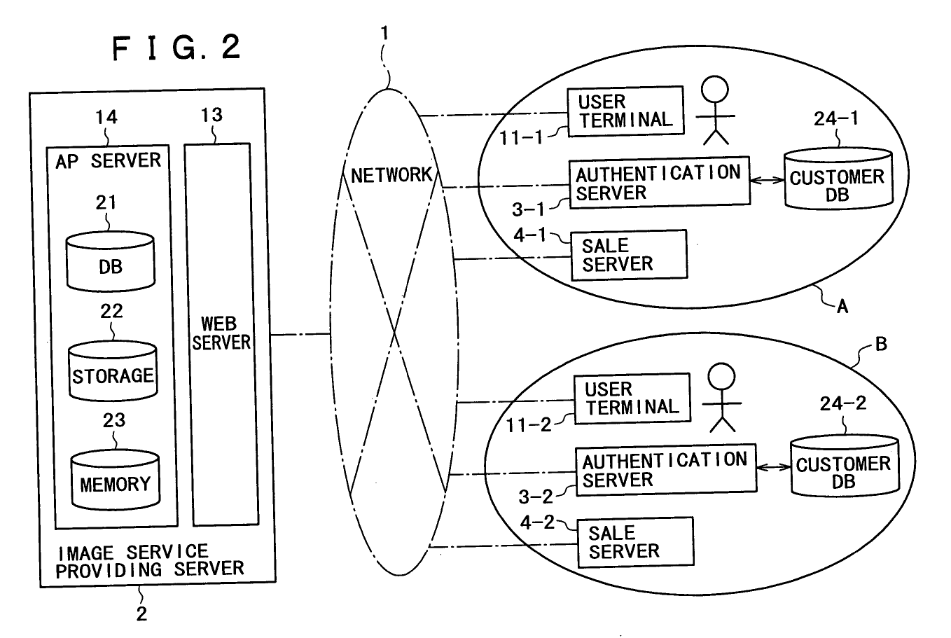

Referring to FIG. 2, there is shown a schematic diagram illustrating in more detail the image service providing system shown in FIG. 1. In addition to the image service providing server 2, authentication server 3, and the sale server 4, a user terminal 11-1 and a user terminal 11-2 owned by users who use the image service providing system are connected to the network 1. The communication between these components is executed through the network 1.

In the example of FIG. 2, area A to which the user terminal 11-1 belongs has an authentication server 3-1 and a sale server 4-1, each managing the user information and the sale information of area A. Area B to which the user terminal 11-2 belongs has an authentication server 3-2 and a sale server 4-2, each managing the user information and the sale information of area B.

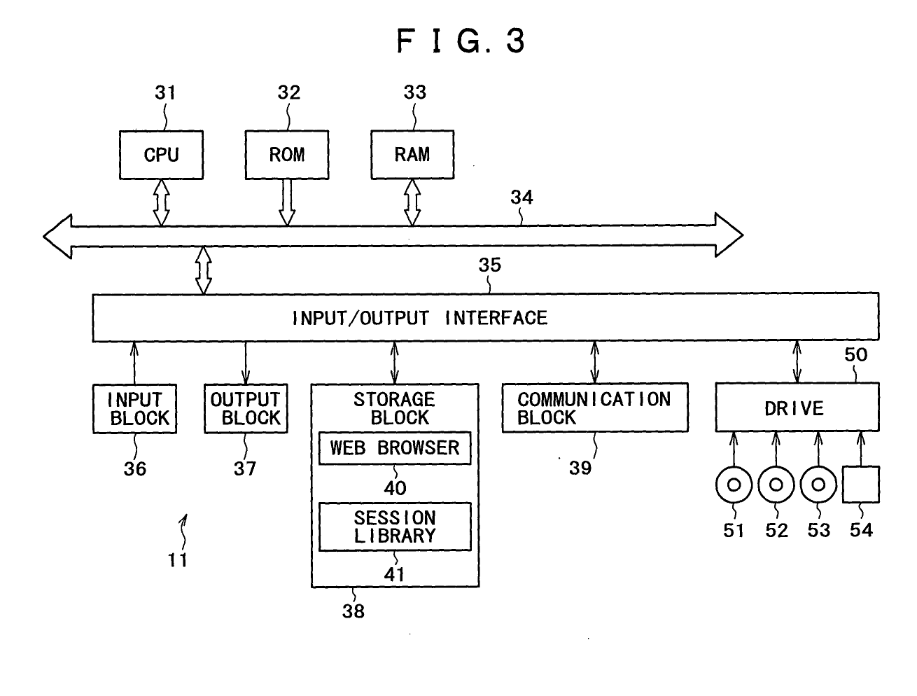

Application software (for example, a Web browser 40 or session library 41 shown in FIG. 3) in which the area information of area A to which the user of the user terminal 11-1 belongs is embedded is installed in the user terminal 11-1. Likewise, application software in which the area information of area B to which the user of the user terminal 11-2 belongs is embedded is installed in the user terminal 11-2. In what follows, the user terminals 11-1 and 11-2 are generically referred to as the user terminal 1 unless otherwise specified.

The image service providing server 2 includes a Web server 13 and an application (AP) server 14. The Web server 13 receives various information from the user terminal 11, the authentication server 3 or the sale server 4 via the network 1 and supplies the received information to the application (AP) server 14. The Web server 13 also receives various information from the application server 14 and sends the received information to the user terminal 11, authentication server 3 or the sale server 4 via the network 1. Therefore, the Web server 13 not only suppresses the load due to the access from the user terminal 11 but also provides the capabilities of a proxy server for the connection from the outside of the image service providing system to the authentication server 3.

Receiving a request for the authentication of the user terminal 11 from the Web server 13, the application server 14 selects the authentication server 3 of the corresponding area on the basis of the area information received from the user terminal 11 and instructs the authentication server 3 for the authentication of the user terminal 11. It should be noted that the authentication instruction from the application server 14 to the authentication server 3 is sent to the authentication servers 3 of all areas through the same library (authentication library 103 shown in FIG. 5).

In the example of FIG. 2, for the authentication request from the user terminal 11-1, the authentication server 3-1 of area A is selected and, for the authentication request from the user terminal 11-2, the authentication server 3-2 of area B is selected. The authentication server 3-1 and the authentication server 3-2 have a customer database (DB) 24-1 and a customer database 24-2 respectively and execute the authentication processing for the user terminal 11-1 and the user terminal 11-2 on the basis of the user information stored in the customer database 24-1 and the customer database 24-2 respectively. It should be noted that, in what follows, the customer database 24-1 and the customer database 24-2 are generically referred to as the customer database 24 unless otherwise specified.

Also, the application server 14 has a database (DB) 21 for storing image information such as album names and image names, a storage 22 for storing content (such as original content, content thumbnail and content screennail), and a memory 23 for temporarily storing content IDs selected by the user terminal 11.

Being accessed via the Web server 13 from the user terminal 11 authenticated by the authentication server 3, the application server 14 creates in the memory 23 a cart area (memory area) corresponding to the user of the user terminal 11, stores the content ID specified by the user terminal 11 into the created cart area, and sends a cart area ID to the user terminal 11 along with the URL (Universal Resource Locator) of the sale server 4 (selected on the basis of the area information supplied from the user terminal 11 as with the authentication server 3) to which the user terminal 11 belongs. Consequently, the user terminal 11 is redirected to the URL of the sale server 4 of the corresponding area. In the example shown in FIG. 2, the user terminal 11-1 is redirected to the URL of the sale server 4-1 of area A and the user terminal 11-2 is redirected to the URL of the sale server 4-2 of area B.

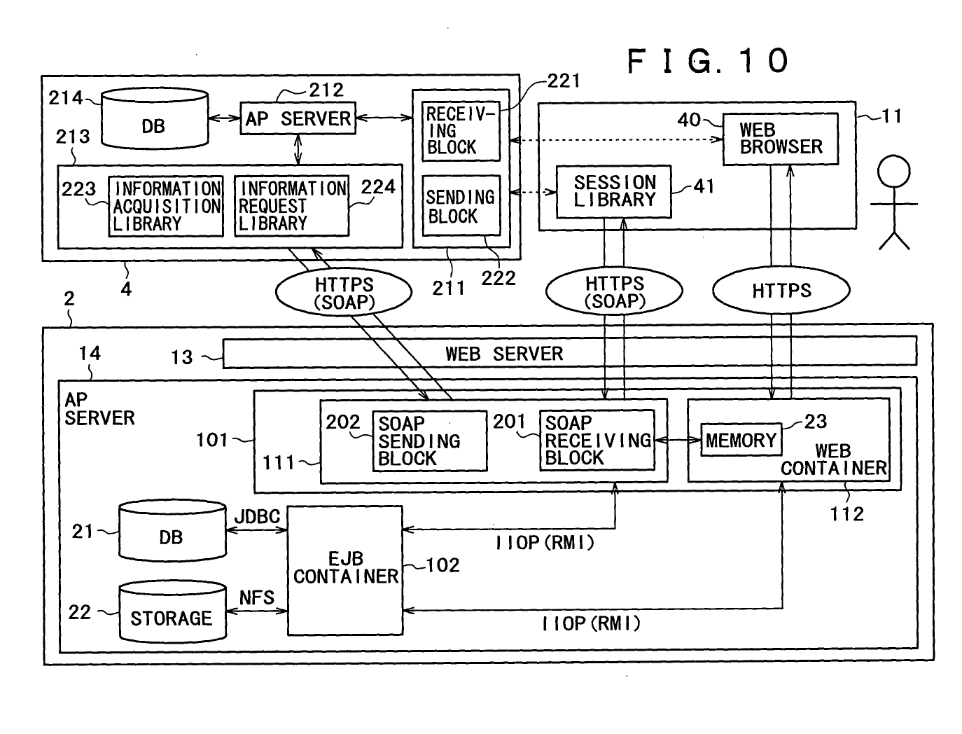

On the basis of the cart area ID received from the user terminal 11, the sale server 4 gets the information (content ID) about the cart area selected by the user terminal 11 from the image service providing server 2. It should be noted that the connection from the sale servers 4 in all areas to the application server 14 is executed by the same library (content acquisition library 213 shown in FIG. 10). After executing various processing operations such as electronic account settlement for example, the sale server 4 gets the content corresponding to this content ID from the storage 22 and provides sale services based on the obtained content to the user of the user terminal 11.

Thus, in the image service providing system, the authentication server 3 and the sale server 4 of an area to which the user terminal 11 belongs are selected by one unit of the image service providing server 2 and each processing is executed in the authentication server 3 and the sale server 4, so that the content provided in the image service providing system or the services based on the content are managed in the image service providing server 2 in a concentrated manner and the load of the processing operations which center on the image service providing server 2 may be distributed.

In addition, the authentication server 3 is used for other network services in each area, so that the management cost may be reduced. Further, the installation of the sale server 4 in each area may provide sale services which are suitable for each area.

Referring to FIG. 3, there is shown an exemplary configuration of the user terminal 11. In FIG. 3, a CPU (Central Processing Unit) 31 executes various processing operations as instructed by programs stored in a ROM (Read Only Memory) 32 or programs loaded from a storage block 38 into a RAM (Random Access Memory) 33. The RAM 33 also stores, from time to time, the data necessary for the CPU 31 to execute various processing operations.

The CPU 31, the ROM 32, and the RAM 33 are interconnected via a bus 34. The bus 34 is also connected to an input/output interface 35.

The input/output interface 35 is connected with an input block 36 composed of a keyboard and a mouse, an output block 37 composed of a display unit such as a CRT (Cathode Ray Tube) or an LCD (Liquid Crystal Display) and a speaker, the storage block 38 constituted by a hard disk, and a communication block 39 composed of a modem and a terminal adaptor. The communication block 39 executes communication processing via the network 1.

The Web browser 40 and session library 41 are stored (or installed) in the storage block 38. The Web browser 40, for example, Internet Explorer (trademark) of Microsoft Corporation or Netscape Navigator (trademark) of Netscape Communications Corp. displays on the output block 37 various data in HTML (Hyper Text Markup Language) format supplied from the image service providing server 2 via the communication block 39, and transfers commands entered by the user through the input block 36.

The session library 41 is a JAVA(R) standardized library, which is an application for getting and reproducing the content of the image service providing server 2 installed at the shipment of the user terminal 11. It should be noted that, at the shipment of the user terminal 11, the area information of the user terminal 11 is embedded in the Web browser 40 or the session library 41 in advance.

The input/output interface 35 is also connected with the drive 50 as required, on which a magnetic disk 51, an optical disk 52, a magneto-optical disk 53, or a semiconductor memory 54 is appropriately loaded. The computer programs read from one of three media are being installed in the storage block 38 as required.

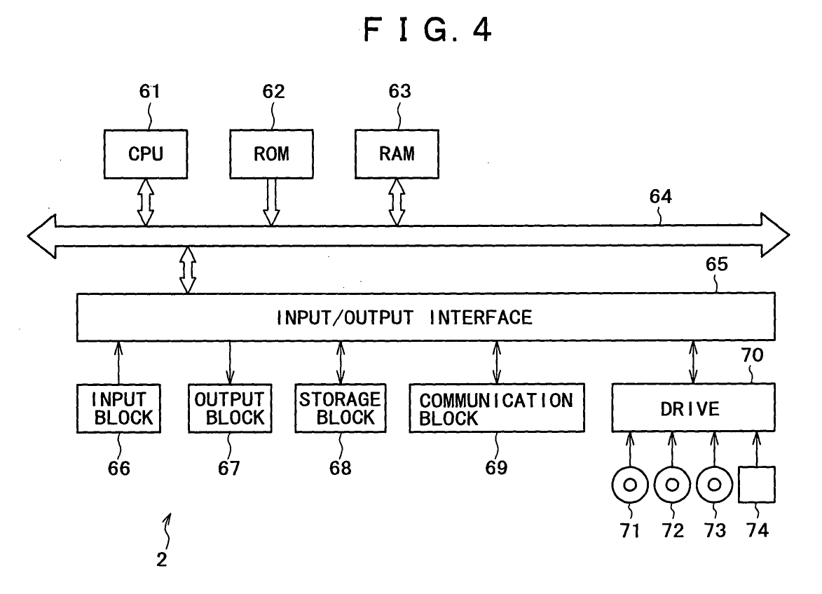

Referring to FIG. 4, there is shown an exemplary configuration of the image service providing server 2. Components, a CPU 61 through a communication block 69 and a drive 70 through a semiconductor memory 74 shown in FIG. 4, are basically the same in function as the components, the CPU 31 through communication block 39 and the drive 50 through the semiconductor memory 54, so that their description will be skipped.

However, the storage block 68 stores application programs (for example, a Java(R) componentware frame work) for executing each processing operation (user authentication processing or service providing processing to be described later) of the image service providing server 2.

Although the illustration is omitted, the authentication server 3 or the sale server 4 is basically the same in function as the image service providing server 2 shown in FIG. 4. Therefore, in what follows, the configuration of the image service providing server 2 is referred to also as the configuration of the authentication server 3 or the sale server 4 as required.

Referring to FIG. 5, there is shown the exemplary functional configurations of the image service providing server 2 and the authentication server 3 which execute user authentication processing in the image service providing system. It should be noted that, with reference to FIG. 5, components similar to those previously described with reference to FIGS. 1 through 4 are denoted by the same reference numerals and omitted from the following description for the brevity.

The application server 14 of the image service providing server 2 is constituted by a Web layer 101, an EJB (Enterprise Java(R) Beans) container 102, the authentication library 103, the database 21, and the storage 22.

The Web layer 101 is constituted by a SOAP (Simple Object Access Protocol) server 111 and a Web container 112 and has the interface function of the image service providing server 2 to the user terminal 11 in order to execute the processing of communication with the user terminal 11. The SOAP server 111 is an external interface (for example, API (Application Programming Interface)) corresponding to the session library 41 of the user terminal 11 or the content acquisition library 213 (FIG. 10 to be described later), receiving the access from the session library 41 of the user terminal 11 and sending various data such as the content of the image service providing server 2 in response to the access from the session library 41. The protocols for controlling the communication between the session library 41 and the SOAP server 111 are HTTPS (Hyper Text Transfer Protocol Secure) which is higher in security level than HTTP (Hyper Text Transfer Protocol) and SOAP which is a protocol based on XML for sharing distributed information.

The Web container 112 is constituted by Java(R)Servlet and JSP (Java(R) Server Pages) for example, receiving command information from the Web browser 40 of the user terminal 11 and sending various data in response to the received command information. The protocol for controlling the communication between the Web browser 40 and the Web container 112 is the HTTPS protocol for example.

The EJB container 102 is a Java(R) componentware framework constituted by JDBC (Java(R) Database Connectivity), Java(R) Mail, JTA (Java(R) Transaction API), and JMF (Java(R) Media Framework API) for example and executes the control of the entire application server 14. The EJB container 102 controls the SOAP server 111 and the Web container 112 through IIOP (Internet Inter Orb Protocol) by use of the RMI (Remote Method Invocation) capability, manages the database 21 by use of JDBC, and manages the storage 22 by use of NFS(R) (Network File System). Receiving a request for content information or content from the SOAP server 111 through the above-mentioned protocols, the EJB container 102 gets the information about the requested content from the database 21 or gets the requested content from the storage 22 to supply the obtained information or content to the SOAP server 111.

Receiving an authentication request from the user terminal 11 through the SOAP server 111 or the Web container 112, the EJB container 102 selects the authentication server 3 corresponding to the area of the user terminal 11 on the basis of the area information of the user terminal 11, controls the authentication library 103, and sends the authentication command of the user terminal 11 to the selected authentication server 3. Namely, the EJB container 102 executes the authentication command on any authentication server 3 by controlling the authentication library 103. Consequently, the interface from the authentication server 3 can be integrated.

The authentication library 103 is a JAVA(R) standardized library configured by an authentication sending library 113 and an authentication receiving library 114. The authentication sending library 113 sends various kinds of information to the authentication server 3 selected by the EJB container 102 via the Web server 13 and the network 1. The authentication receiving library 114 supplies each piece of information received from the authentication server 3 via the network 1 and the Web server 13 to the EJB container 102. The protocols for controlling the communication between the authentication library 103 and the authentication server 3 are HTTPS and SOAP for example.

The authentication server 3 is configured by a SOAP server 121, an application (AP) server 122, and a customer database 24. The SOAP server 121 provides the external interface (for example, API (Application Programming Interface)) corresponding to the authentication library 103 of the image service providing server 2 and is configured by a SOAP receiving block 131 for receiving the authentication instruction supplied from the authentication sending library 113 to the user terminal 11 and a SOAP sending block 132 for sending each piece of information associated with the authentication of the user terminal 11 to the authentication receiving library 114.

The application server 122 searches the customer database 24 on the basis of the authentication command received by the SOAP receiving block 131 for the authentication of the user terminal 11 and the user authentication information (for example, login ID and password information), thereby executing the authentication of the user terminal 11 acquiring the user information corresponding to the login ID of the user terminal 11 from the customer database. In addition, the application server 122 sends the authentication result information corresponding to the user terminal or the user information of the user terminal 11 to the image service providing server 2 via the SOAP sending block 132.

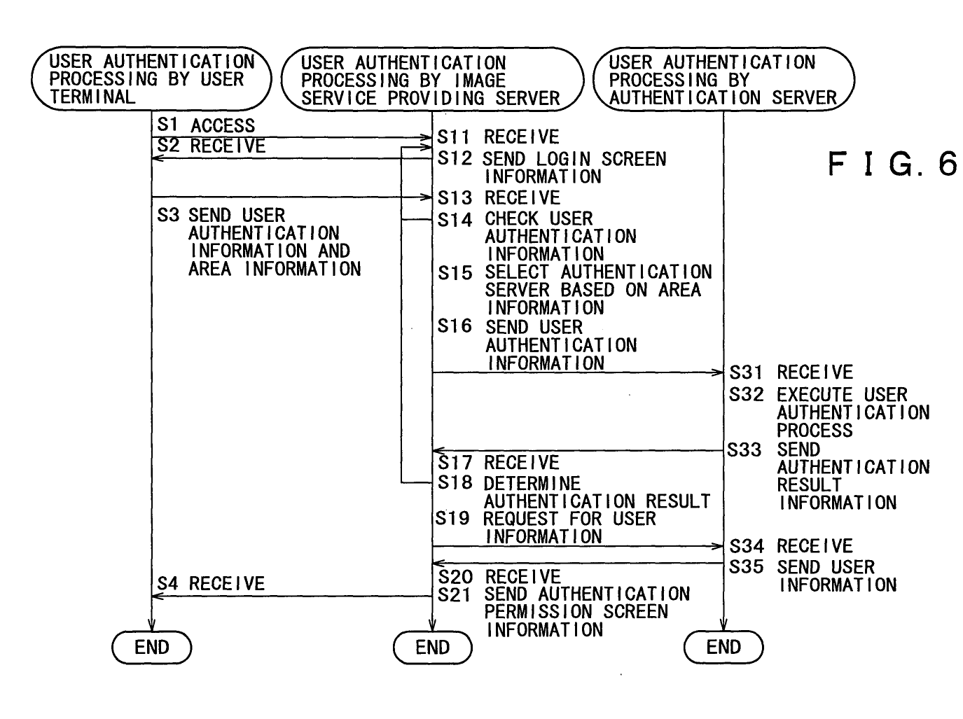

The following describes the user authentication processing by the image service providing system with reference to the flowchart shown in FIG. 6.

In order to access the image service providing server 2, the user of the user terminal 11 operates the mouse for example of the input block 36 of the user terminal 11 to start the session library 41 stored (or installed) in the storage block 38, thereby instructing the connection to the image service providing server 2. Namely, the CPU 31 of the user terminal 11 executes various processing operations in accordance with the session library 41 loaded from the storage block 38 into the RAM 33. In step S1, the session library 41 of the user terminal 11 controls the communication block 39 to access the image service providing server 2 via the network 1.

In step S11, the SOAP server 111 of the image service providing server 2 receives the access from the user terminal 11 via the Web server 13 and, in step S12, sends the login screen information to the image service providing server 2 via the Web server 13 and network 1.

In step S2, the session library 41 of the user terminal 11 receives the login screen information from the image service providing server 2 via the communication block 39 and displays the received information on the monitor of the output block 37. Looking at the login screen displayed on the monitor of the output block 37, the user of the user terminal 11 operates the keyboard for example of the input block 36 to enter user's predetermined login ID and password. In response, in step S3, the session library 41 sends the entered login ID and password to the image service providing server 2 via the communication block 39 and the network 1 as the user authentication information of the user terminal 11. At the same time, the area information (for example, country code and language code) embedded in the session library 41 at the time of shipment (or installation) is also sent.

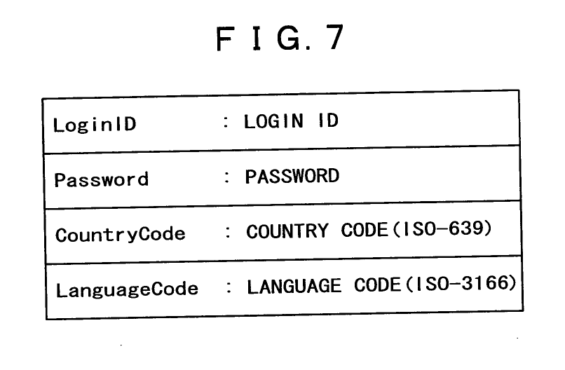

Referring to FIG. 7, there is shown an exemplary configuration of the user authentication information and area information sent from the user terminal 11 to the image service providing server 2. In the example of FIG. 7, LoginID (login ID) and Password (password) which form the user authentication information and CountryCode (country code based on ISO-639) and LanguageCode (language code based on ISO-3166) which form the area information are sent.

In step S13, the SOAP server 111 of the image service providing server 2 receives the user authentication information and the area information from the user terminal 11 via the Web server 13 and supplies the received information to the EJB container 102. In step S14, the EJB container 102 executes the confirmation of the login ID and password of the user identification information. To be more specific, the EJB container 102 determines whether or not the login ID and the password have been entered each in the specified characters and the specified number of characters. If the login ID and the password are found not entered each in specified characters and the specified number of characters in step S14, then the procedure returns to step S12 to repeat the above-mentioned processing therefrom.

If the login ID and the password are found entered each in specified characters and the specified number of characters in step S14, then the EJB container 102 selects, in step S15, the authentication server 3 of the area corresponding to the area information from among the authentication servers 3 of all areas on the basis of the area information (country code and language code) received from the user terminal 11. In step S16, the EJB container 102 controls the authentication sending library 113 to send the user authentication information of the user terminal 11 to the authentication server 3 selected in step S15 via the Web server 13 and the network 1.

In step S31, the SOAP receiving block 131 of the authentication server 3 receives the user authentication information of the user terminal 11 supplied from the image service providing server 2 and supplies the received information to the application server 122. In step S32, on the basis of the user authentication information of the user terminal 11, the application server 122 searches the customer database 24 for the user information to determine whether or not to authenticate the user terminal 11, supplying the authentication result information for the user terminal 11 to the SOAP sending block 132. In step S33, the SOAP sending block 132 sends the authentication result information to the image service providing server 2 via the network 1.

In step S17, the authentication receiving library 114 of the image service providing server 2 receives the authentication result information for the user terminal 11 from the authentication server 3 via the Web server 13 and supplies the received information to the EJB container 102. In step S18, the EJB container 102 determines, on the basis of the received authentication result information, whether or not the user terminal 11 has been authenticated by the authentication server 3. If the user terminal 11 is found not authenticated by the authentication server 3, then the procedure returns to step S12 to repeat the above-mentioned processing therefrom.

If the user terminal 11 is found authenticated by the authentication server 3 in step S18, then the EJB container 102 controls the authentication sending library 113 in step S19 to send a request for the user information of the user terminal 11 to the authentication server 3 which has authenticated the user terminal 11, via the Web server 13 and the network 1. This user information includes the nickname in the image service providing system and the electronic mail address registered by user of the user terminal 11.

In step S34, the SOAP receiving block 131 of the authentication server 3 receives the request for the user information of the user terminal 11 from the image service providing server 2 and supplies the received request to the application server 122. In step S35, the application server 122 gets the user information of the user terminal 11 stored in the customer database 24 and controls the SOAP sending block 132 to send the user information of the user terminal 11 to the image service providing server 2 via the network 1.

In step S20, the authentication receiving library 114 of the image service providing server 2 receives the user information of the user terminal 11 from the authentication server 3 via the Web server 13 and supplies the received user information to the EJB container 102. In the S21, the EJB container 102 controls the SOAP server 111 to send the screen information indicative of authentication permission to the user terminal 11 via the Web server 13 and the network 1 on the basis of the received user information of the user terminal 11.

In step S4, the session library 41 of the user terminal 11 displays the screen indicative of authentication permission received via the communication block 39 onto the monitor of the output block 37.

Thus, in the image service providing system, all the accesses from the user terminal 11 are received by the image service providing server 2, so that the same services may be provided to all user terminals 11. In addition, the same common interface is used between the image service providing server 2 and all authentication servers 3, so that the common services of the image service providing system may be installed and managed and operated in a concentrated manner. This management and operation in a concentrated manner lowers the management and operation costs of the image service providing system.

Further, the authentication processing by the image service providing system is executed by the authentication server 3 which corresponds to the area information of each user terminal 11, so that the processing load of the image service providing server 2 may be mitigated. Moreover, the authentication server 3 of each area can be used also for the authentication of other network services, so that the authentication server 3 may be appropriated for other services, thereby allowing the management of the users of a plurality of network services in a concentrated manner. Consequently, each user can use a plurality of network services with a single login ID and a single password, thereby enhancing the user friendliness.

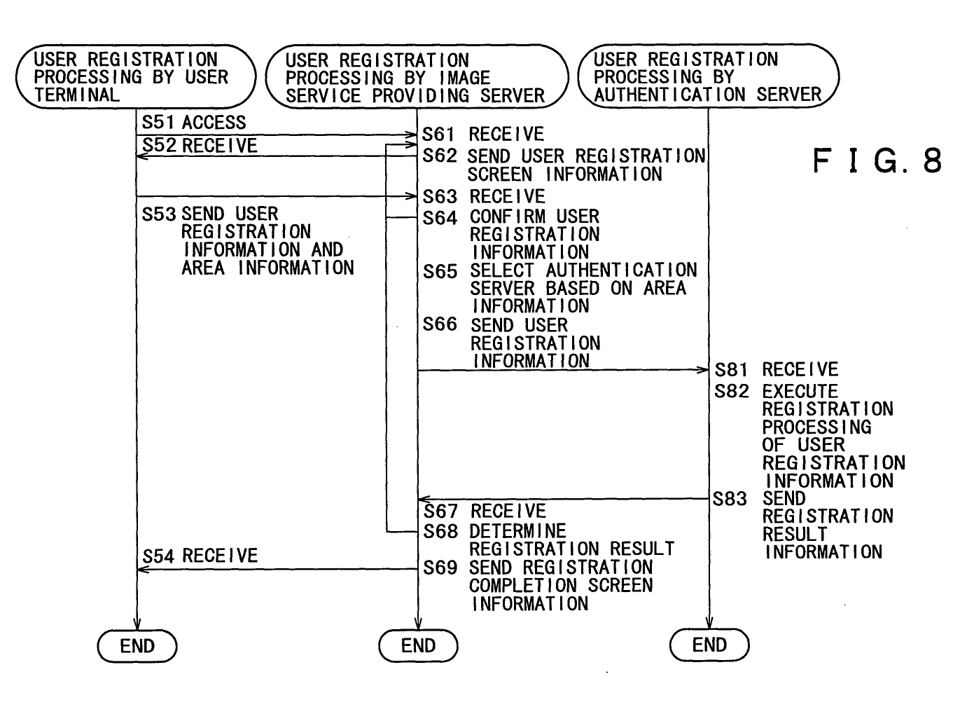

The following describes the user registration processing of the image service providing system which is executed by the user terminal 11 to access the image service providing server 2 for the first time with reference to the flowchart shown in FIG. 8.

It should be noted that the processing operations of steps S51 through S54, steps S61 through S69, and steps S81 through S83 are basically the same as those of steps S1 through S4, steps S11 through S18, step S21, and steps S31 through S33 shown in FIG. 6. Differences lie in that, while the information to be processed in steps S2 and S12 shown in FIG. 6 is login screen information, user registration screen information is processed in steps S52 and 62 shown in FIG. 8; while the information to be processed in steps S3, S13, S14, S16, and S31 shown in FIG. 6 is user authentication information, the information to be processed in steps S53, S63, S64, S66, and S81 shown in FIG. 8 is user registration information.

It should also be noted that, while user authentication is executed in step S32 shown in FIG. 6, the registration of user registration information is executed in step S82 shown in FIG. 8; while the information to be processed in steps S17, S18, and S33 shown in FIG. 6 is authentication result information, registration result information is processed in steps S67, S68, and S83 shown in FIG. 8; and, while the information to be processed in steps S4 and S21 shown in FIG. 6 is authentication permission screen information, the information to be processed in steps S54 and S69 shown in FIG. 8 is registration completion screen information.

To be more specific, in step S61, the SOAP server 111 of the image service providing server 2 receives the access from the user terminal 11 and, in step S62, sends user registration screen information for the image service providing server 2 to the user terminal 11.

In step S52, the session library 41 of the user terminal 11 receives the user registration screen information and, in step S53, sends the user registration information (for example, login ID and password) of the user terminal 11 entered by the user through the input block 36 and the area information embedded in the session library 41 to the image service providing server 2.

In step S63, the SOAP server 111 of the image service providing server 2 receives the user registration information and the area information from the user terminal 11. In step S64, the EJB container 102 executes the confirmation of the user registration information and, in step S65, selects the authentication server 3 of the area corresponding to the area information on the basis of the area information received from the user terminal 11, and, in step S66, controls the authentication sending library 113 to send the user registration information of the user terminal 11 to the selected authentication server 3.

In step S81, the SOAP receiving block 131 of the authentication server 3 receives the user registration information of the user terminal 11 and supplies the received information to the application server 122. In step S82, the application server 122 registers the user registration information of the user terminal 11 into the customer database 24 and supplies the registration result information about the user registration information corresponding to the user terminal 11 to the SOAP sending block 132. In step S83, the SOAP sending block 132 sends this registration result information to the image service providing server 2.

In step S67, the authentication receiving library 114 of the image service providing server 2 receives the registration result information for the user terminal 11 from the authentication server 3 and supplies the received information to the EJB container 102. In step S68, on the basis of the received registration result information, the EJB container 102 determines whether or not the user terminal 11 has been authenticated by the authentication server 3. If the user terminal 11 is found authenticated by the authentication server 3, then, in step S69, the EJB container 102 controls the SOAP server 111 to create the screen information indicative of the completion of registration, sending this information to the user terminal 11.

In step S54, the session library 41 of the user terminal 11 displays the screen indicative of the completion of registration received via the communication block 39 onto the monitor of the output block 37.

Thus, the user registration processing of the image service providing system is executed by the authentication server 3 of the area corresponding to the user terminal 11 via the image service providing server 2.

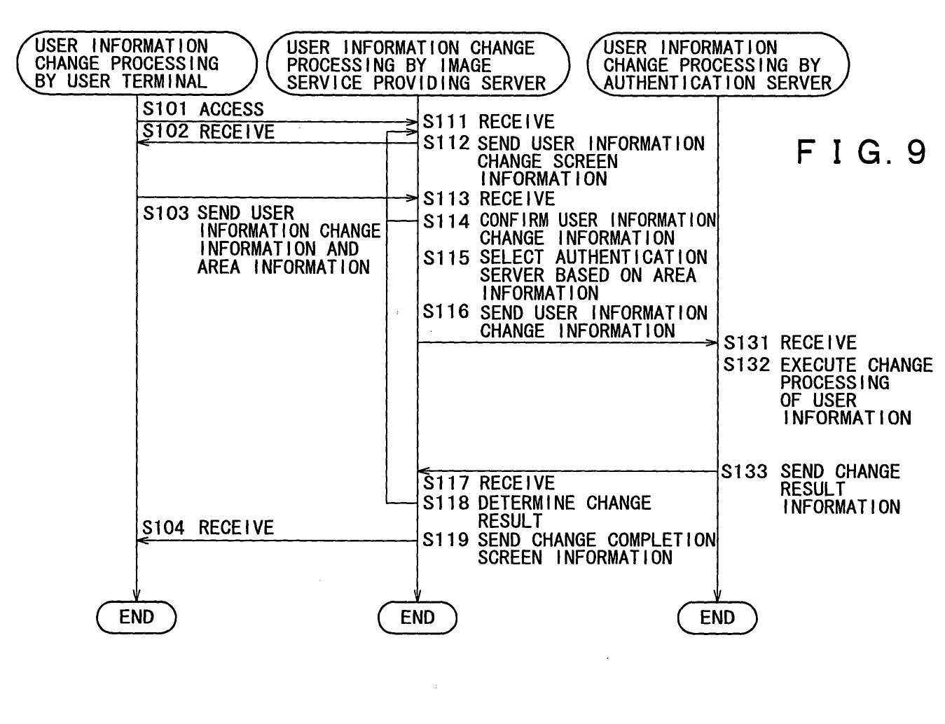

The following describes, with reference to the flowchart shown in FIG. 9, user information change processing for changing the user information registered in the customer database 24 of the authentication server 3 in the image service providing system. This user information change processing is executed in a state in which the user terminal 11 has been authenticated (or logged in) by the user authentication processing described with reference to the flowchart shown in FIG. 6.

It should be noted that the processing operations of steps S101 through S104, steps S111 through S119, and steps S131 through S133 shown in FIG. 9 are generally the same as those of steps S1 through S4, steps S11 through S18, step S21, and steps S31 through S33 shown in FIG. 6. Differences lie in that, while the information to be processed in steps S2 and S12 shown in FIG. 6 is login screen information, user information change screen information is processed in steps S102 and S112 shown in FIG. 9; and, while the information to be processed in steps S3, S13, S14, S16 and S31 shown in FIG. 6 is user authentication information, the information to be processed in steps S103, S113, S114, S116 and S131 shown in FIG. 9 is user information change information.

Differences also lie in that, while user authentication processing is executed in step S32 shown in FIG. 6, user information change processing is executed in step S132 shown in FIG. 9; while the information to be processed in steps S17, S18, and S33 shown in FIG. 6 is authentication result information, change result information is processed in steps S117, S118, and S133 shown in FIG. 9; and, while the information to be processed in step S4 and S12 shown in FIG. 6 is authentication permission screen information, the information to be processed in steps S104 and S119 shown in FIG. 9 is change completion screen information.

To be more specific, in step S101, when the session library 41 accesses the image service providing server 2 with the user terminal 11 authenticated (logged in) by the user authentication processing, the SOAP server 111 of the image service providing server 2 receives access from the user terminal 11 in step S111 and sends the user information change screen information for the image service providing server 2 to the user terminal 11.

In step S102, the session library 41 of the user terminal 11 receives the user information change screen information and sends, in step S103, user change information (for example, login ID and password) of the user terminal 11 entered by the user through the input block 36 and the area information embedded in the session library 41 to the image service providing server 2.

In step S113, the SOAP server 111 of the image service providing server 2 receives the user information change information and the area information from the user terminal 11. In step S114, the EJB container 102 executes the confirmation of the user information change information and, in step S115, on the basis of the area information from the user terminal 11, selects the authentication server 3 of the area corresponding to the area information and, in step S116, controls the authentication sending library 113 to send the user information change information of the user terminal 11 to the selected authentication server 3.

In step S131, the SOAP receiving block 131 of the authentication server 3 receives the user information change information and supplies the received information to the application server 122. In step S132, the application server 122 executes the processing of changing the user information of the user terminal 11. To be more specific, the application server 122 searches the customer database 24 for the user information of the user terminal 11 and, on the basis of the received user information change information, changes the retrieved user information of the user terminal 11, supplying to the SOAP sending block 132 change result information indicating whether or not the change of the user information for the user terminal 11 has been completed. In step S133, the SOAP sending block 132 sends the received change result information to the image service providing server 2.

In step S117, the authentication receiving library 114 of the image service providing server 2 receives the change result information for the user terminal 11 from the authentication server 3 and supplies the received information to the EJB container 102. In step S118, on the basis of the received change result information, the EJB container 102 determines whether or not the user information of the user terminal 11 has been changed. If the user information is found changed, then, in step S119, the EJB container 102 controls the SOAP server 111 to create the screen information indicative of the completion of change, sending the created screen information to the user terminal 11.

In step S104, the session library 41 of the user terminal 11 displays the change completion screen received via the communication block 39 onto the monitor of the output block 37.

Thus, the user information change processing of the image service providing system is executed by the authentication server 3 of the area corresponding to the user terminal 11 via the image service providing server 2.

Referring to FIG. 10, there is shown exemplary functional configurations of the image service providing server 2 and the sale server 4 which execute service providing processing in the image service providing system. It should be noted that, with reference to FIG. 10, components similar to those previously described with reference to FIGS. 1 through 5 are denoted by the same reference numerals and omitted from the following description for brevity.

In the example shown in FIG. 10, the user terminal 11 has already been authenticated in the image service providing system by the user authentication processing described with reference to the flowchart shown in FIG. 6.

The SOAP server 111 of the image service providing server 2 is configured by a SOAP receiving block 201 for receiving various data from a user terminal 11 or a sale server 4 and a SOAP sending block 202 for sending various data to the user terminal 11 or the sale server 4. Protocols for controlling the communication between the user terminal 11 or the sale server 4 and the SOAP server 111 are a protocol such as HTTP which is lower in security level than HTTPS and SOAP. Also, HTTP and so on are used for the protocols for controlling the communication between a Web browser 40 and the Web container 112.

The Web container 112 has a memory 23 inside. This memory 23 is controlled by not only the Web container 112 but also the SOAP receiving block 201 of the SOAP server 111. Receiving the access from the user terminal 11, the Web container 112 and the SOAP receiving block 201 create a cart area (memory area) corresponding to the user of the user terminal 11 in the memory 23 and, upon reception of the specification of content (image, album, etc.) from the user terminal 11, stores its content ID into the cart area for the user terminal 11 in the memory 23. It should be noted that this cart area is created by the SessionOjbect capability of Java(R)Servlet for example and automatically deleted if there is no connection for a preset predetermined period of time.

The sale server 4 is configured by the Web server 211, an application (AP) server 212, a content acquisition library 213, and a database (DB) 214. The Web server 211 has the interface capability of the sale server 4 for the user terminal 11 for executing the processing of communication with the user terminal 11 via the network 1 and is configured by a receiving block 221 for receiving various kinds of information such as requests from the user terminal 11 and a sending block 222 for sending various kinds of information to the user terminal 11.

The application (AP) server 212 executes the control of the entire sale server 4. For example, the application server 212 gets various data from the database (DB) 214 in which the screen information provided by the sale server 4 are stored and controls the content acquisition library 213 to get various data from the image service providing server 2.

The content acquisition library 213 is configured by an information acquisition library 223 and an information request library 224 and executes the processing of communication with the image service providing server 2 via the network 1. The information request library 224 requests the SOAP receiving block 201 of the image service providing server 2 for the content ID of the cart area ID on the basis of the cart area ID received from the user terminal 11 and for the content information on the basis of the content ID. The information acquisition library 223 gets the content ID or content information supplied from the SOAP sending block 202 of the image service providing server 2.

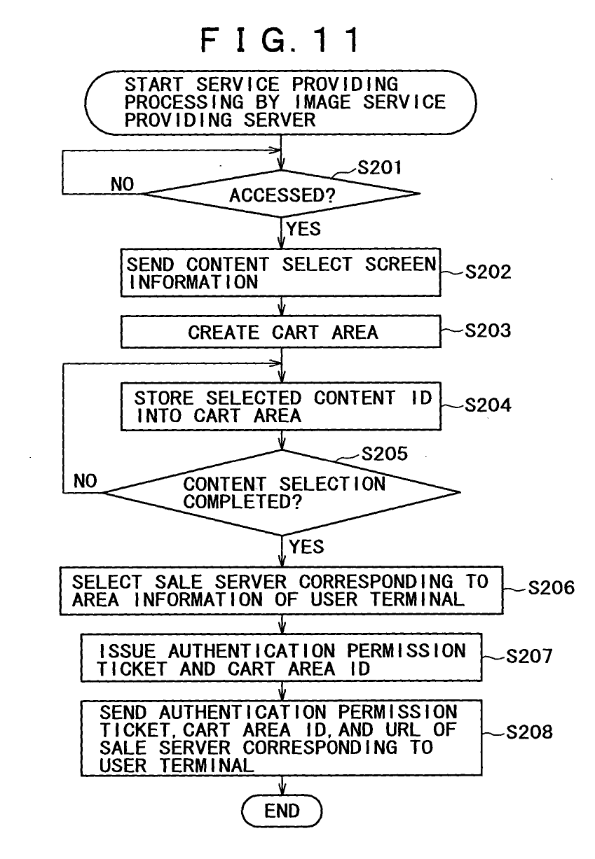

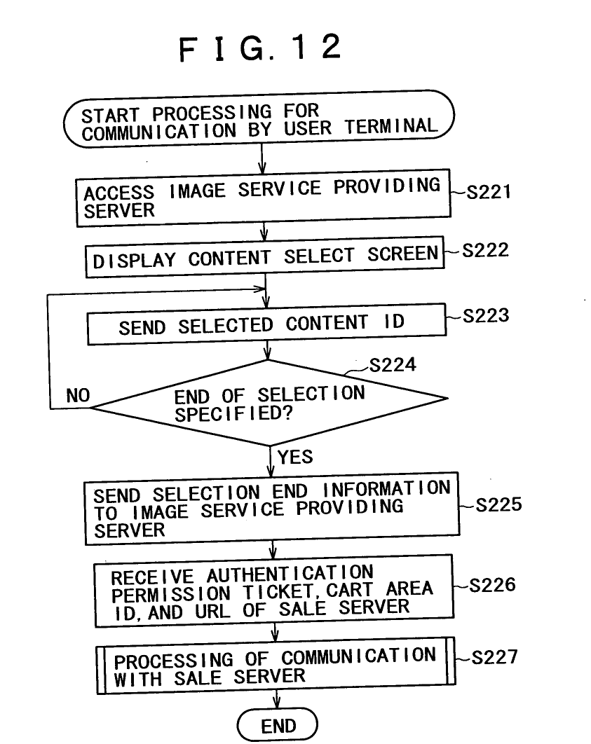

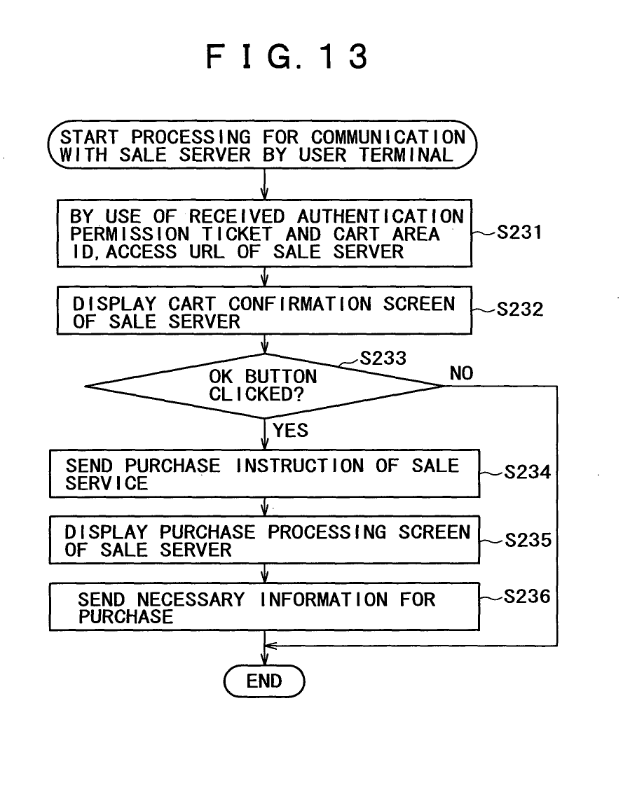

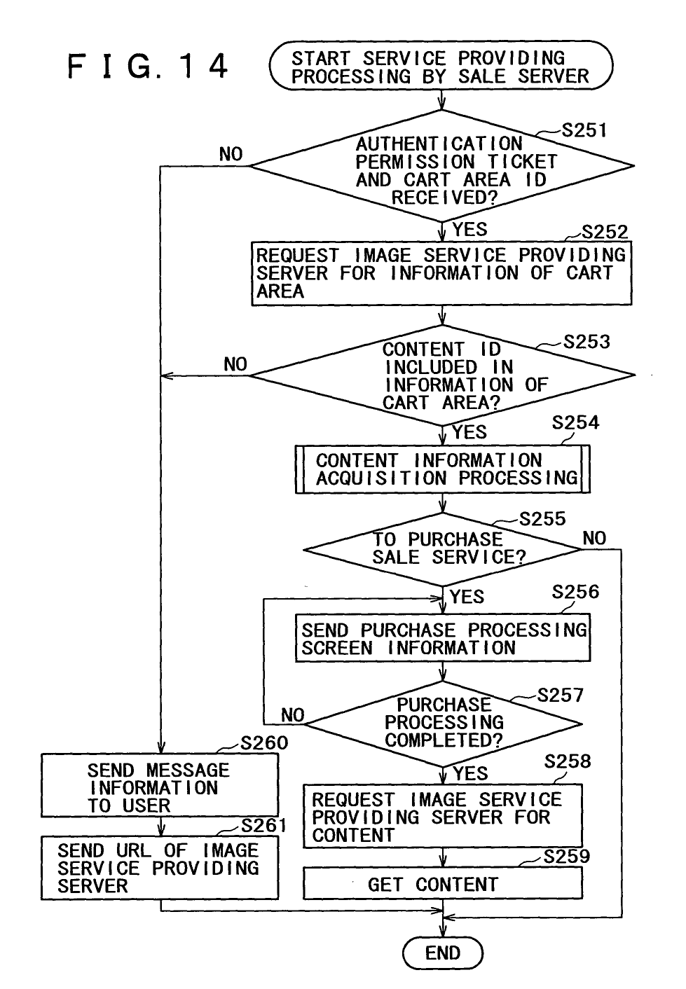

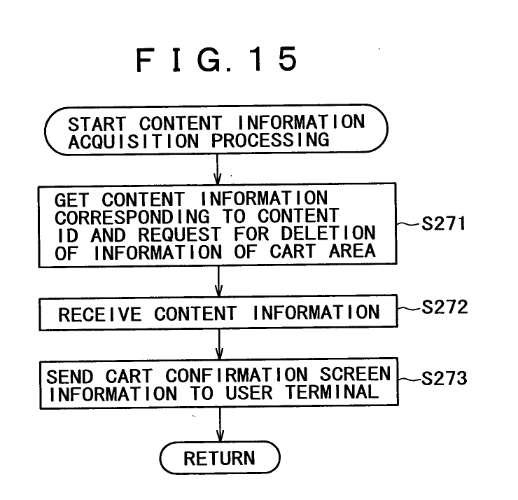

The following describes the service providing processing of the image service providing system with reference to the flowcharts shown in FIGS. 11 through 15. It should be noted that FIG. 11 shows the service providing processing of the image service providing server 2, FIGS. 12 and 13 show the communication processing of the user terminal 11 corresponding to the service providing processing of the image service providing server 2 shown in FIG. 11, FIGS. 14 and 15 show the service providing processing of the sale server 4 corresponding to the communication processing of the user terminal 11 shown in FIGS. 12 and 13, and FIG. 16 shows the content information sending processing of the image service providing server 2 corresponding to the processing of the sale server 4 shown in FIGS. 14 and 15. These processing operations are executed in a state in which the user terminal 11 has been authenticated (logged in) by the user authentication processing described with reference to the flowchart shown in FIG. 6.

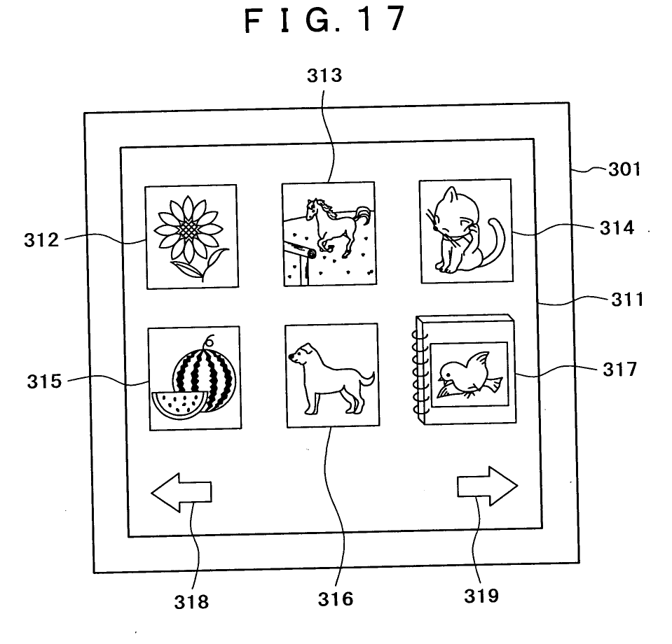

With the user terminal 11 authenticated (logged in) by the user authentication processing, the session library 41 of the user terminal 11 accesses the image service providing server 2 (step S221 of FIG. 12). The SOAP receiving block 201 of the image service providing server 2 is in a wait state until access comes from the user terminal 11. If access is found made by the user terminal 11 in step S201, the SOAP receiving block 201 sends the information of a content select screen (shown in FIG. 17 to be described later) of the image service providing server 2 to the user terminal 11 via the Web server 13 and the network 1 in step S202, and creates a cart area (memory area) corresponding to the user of the user terminal 11 in the memory 23 in step S203.

The content ID selected by the user on the content select screen supplied in step S202 is sent from the user. terminal 11 (step S223 of FIG. 12). In step S204, the SOAP receiving block 201 receives this content ID via the Web server 13 and stores the received content ID into the cart area of the user terminal 11 in the memory 23.

Then, the user terminal 11 sends the information that the content selection has completed (step S225 of FIG. 12). Upon reception of this information via the Web server 13, the SOAP receiving block 201 determines in step S205 that the content selection by the user terminal 11 has completed and the procedure goes to step S206. If the content selection by the user terminal 11 is found not completed in step S205, then the procedure returns to step S204 to repeat the above-mentioned processing therefrom.

In step S206, the EJB container 102 selects the sale server 4 corresponding to the area information of the user terminal 11 in the same manner as the processing of selecting the authentication server 3 (step S15 shown in FIG. 6). In step S207, the EJB container 102 issues an authentication permission ticket indicative that the user terminal 11 has been authenticated in the image service providing server 2 and the cart area ID of the cart area corresponding to the user of the user terminal 11. In step S208, the SOAP receiving block 201 sends the issued authentication permission ticket and cart area ID to the user terminal 11 via the Web server 13 and the network 1 along with the URL of the sale server 4 corresponding to the area information of the user terminal 11. Consequently, the user terminal 11 is redirected to the Web server 211 of the sale server 4.

Thus, in the image service providing server 2, the content ID selected by the user terminal 11 is stored in the cart area corresponding to the user terminal 11. The following describes the communication processing of the user terminal 11 corresponding to the service providing processing of the image service providing server 2 with reference to the flowchart shown in FIG. 12.

With the user terminal 11 authenticated (logged in) by the user authentication processing, the user of the user terminal 11 operates the mouse for example of the input block 36. In response to the operation done on the mouse, the session library 41 of the user terminal 11 controls the communication block 39 to access the image service providing server 2 via the network 1 in step S221. In response, the image service providing server 2 sends content select screen information to the user terminal 11 (step S202 of FIG. 11). In step S222, the session library 41 receives the content select screen information via the communication block 39 and displays a content select screen 301 as shown in FIG. 17 onto the monitor of the output block 37.

Referring to FIG. 17, there is shown an exemplary configuration of the content select screen 301 of the image service providing server 2.

In the content select screen 301, thumbnails 312 through 317 for listing the content that may be provided for the user are arranged on a board 311. Clicking an arrow marker 318 arranged in the lower left of the board 311 by operating the mouse for example of the input block 36 displays a thumbnail group (previous screen) arranged before the thumbnails 312 through 317. Clicking an arrow marker 319 arranged in the lower right of the board 311 displays a thumbnail group (next screen) arranged after the thumbnails 312 through 317. The content provided by the image service providing server 2 includes images (moving images and still images) or an album composed of a plurality of images. In the example shown in FIG. 17, the thumbnails 312 through 316 are each indicated by a single image thumbnail and the thumbnail 317 is indicated in an album form. Consequently, the user knows that the content corresponding to the thumbnails 312 through 316 is image content and the content corresponding to the thumbnail 317 is album content. Operating the mouse for example of the input block 36, the user selects any of these thumbnails 312 through 317 (in this example, the thumbnail 314) to select the content represented by the selected thumbnail.

In response, in step S223, the session library 41 sends the content ID of the content (in this example, the thumbnail 314) selected by the user of the user terminal 11 to the image service providing server 2 by controlling the communication block 39.

The content select processing described above is repeated until the mouse for example of the input block 36 is operated by the user to instruct the end of the content select processing. When the user thus instructs the end of the content select processing, the session library 41 determines in step S224 that the end of the content select processing has been instructed and controls the communication block 39 to send the information about the end of the content select processing to the image service providing server 2 via the network 1 in step S225.

In response, the image service providing server 2 sends back the authentication permission ticket, the cart area ID, and the URL of the sale server 4 corresponding to the area information of the user terminal 11 (step S208 shown in FIG. 11), so that the session library 41 receives the authentication permission ticket, the cart area ID, and the URL of the sale server 4 in step S226 and executes the processing of communication with the sale server 4 in step S227. The following describes this processing of communication with the sale server 4 with reference to the flowchart shown in FIG. 13.

In step S231, the session library 41 controls the communication block 39 by use of the authentication permission ticket and cart area ID received in step S226 to access the URL of the sale server 4 via the network 1.

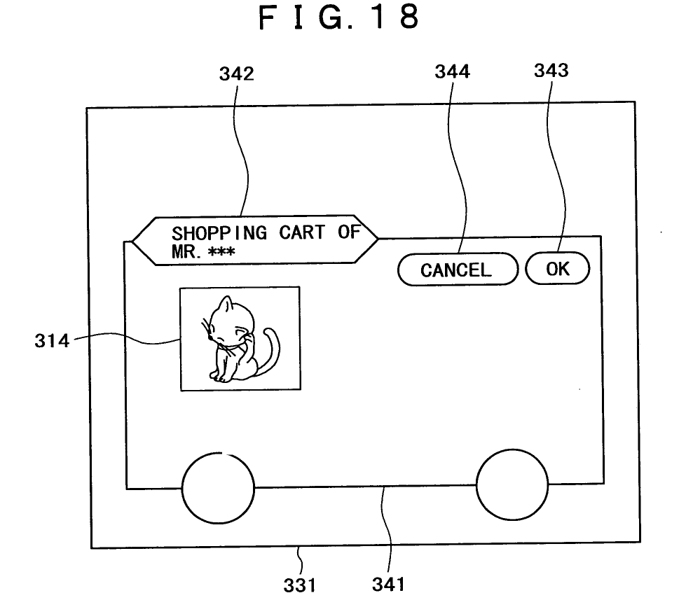

On the basis of the authentication permission ticket and cart area ID received from the user terminal 11, the sale server 4 gets the content ID or the content information from the cart area of the user terminal 11 and sends the cart confirmation screen information of the user terminal 11 (step S273 shown in FIG. 15). In step S232, the session library 41 of the user terminal 11 receives the cart confirmation screen information from the sale server 4 via the communication block 39 and displays a cart confirmation screen 331 as shown in FIG. 18 onto the monitor of the output block 37.

Referring to FIG. 18, there is shown an exemplary configuration of the cart confirmation screen 331.

In the cart confirmation screen 331, a title 342 “Shopping Cart of Mr. ***” indicative of the content information of the cart area of the user of the user terminal 11 is arranged in the upper left of a shopping cart board 341. A thumbnail (in this example, the thumbnail 314) corresponding to the content selected by the user in step S223 is displayed on the shopping cart board 341. In the example of FIG. 18, the thumbnail for only one piece of content is displayed; if the user selects plural pieces of content, the thumbnails for the selected pieces of content are displayed.

An OK button 343 displaying “OK” for specifying the purchase of a sale service by use of the thumbnail 314 for the content and a cancel button 344 displaying “CANCEL” for canceling the purchase of a sale service by use of the thumbnail 314 for the content are also arranged in the upper right of the shopping cart board 341. When the button 343 is clicked with the mouse for example of the input block 36, the session library 41 determines in step S233 that the button 343 has been clicked and sends, in step S234, the instruction for purchasing a sale service by use of the content indicated by the thumbnail 314 to the sale server 4 via the network 1. In response, the purchase processing screen information is supplied from the sale server 4 (step S256 shown in FIG. 14). In step S235, the session library 41 receives the purchase processing screen information from the sale server 4 via the communication block 39 and displays a purchase processing screen onto the monitor of the output block 37.

Checking this purchase processing screen, the user of the user terminal 11 enters such data (for example, the contents of the desired sale service, credit card number, and address) necessary for the purchase of the sale service by use of the content information 314 by operating the keyboard for example of the input block 36. In response, in step S236, the session library 41 sends the data necessary for purchase entered by the user to the sale server 4 via the network 1.

On the other hand, if the cancel button 344 is clicked with the mouse for example of the input block 36 on the cart confirmation screen 331 shown in FIG. 18, then, in step S233, the session library 41 determines that the OK button 343 has not been clicked (cancel button 344 has been clicked), thereby ending the processing.

Thus, in the user terminal 11, sale services of the sale server 4 based on the content in the image service providing server 2 are provided. The following describes the service providing processing of the sale server 4 corresponding to this communication processing of the user terminal 11 with reference to the flowchart shown in FIG. 14.

By use of the authentication permission ticket and cart area ID received from the image service providing server 2, the session library 41 of the user terminal 11 accesses the URL of the sale server 4 (step S231 shown in FIG. 13). The receiving block 221 of the Web server 211 of the sale server 4 receives the authentication permission ticket and the cart area ID from the accessing user terminal 11 and supplies them to the application server 212. In step S251, the application server 212 determines whether or not the authentication permission ticket and the cart area ID have been received from the user terminal 11. In step S251, if the authentication permission ticket and the cart area ID are found received from the user terminal 11, then the application server 212 controls the information request library 224 to send a request for the information about the cart area corresponding to the cart area ID to the image service providing server 2 via the network 1.

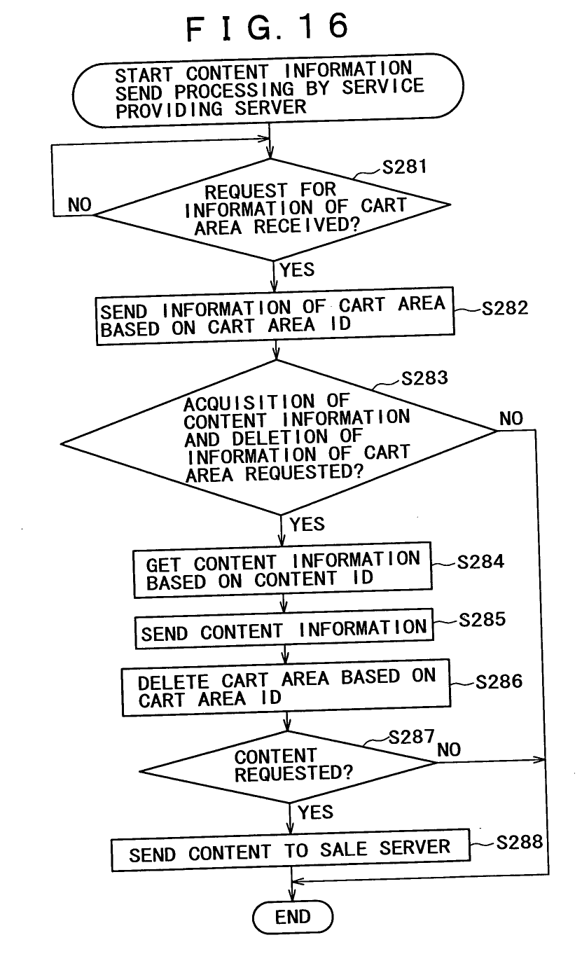

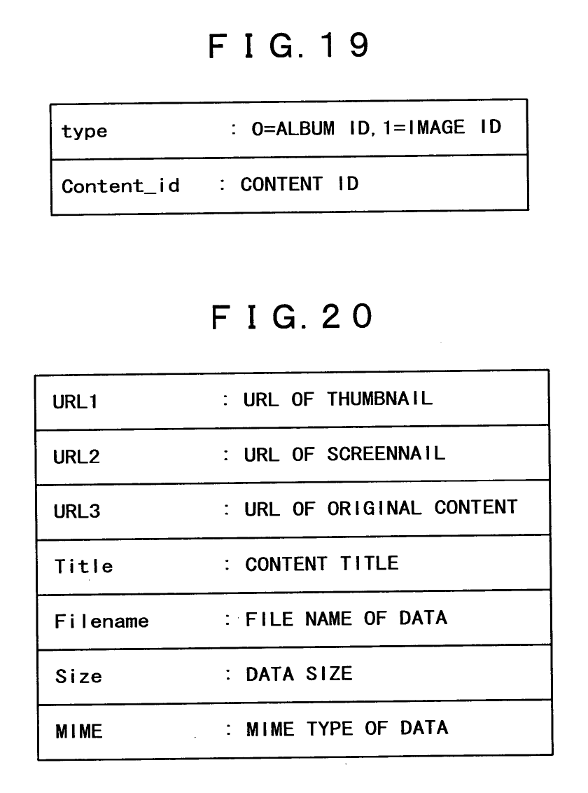

In response, the image service providing server 2 sends the information about the cart area a shown in FIG. 19 corresponding to the cart area ID of the user terminal 11 (step S282 shown in FIG. 16).

Referring to FIG. 19, there is shown an exemplary configuration of the information about the cart area sent from the image service providing server 2 to the sale server 4. In the example of FIG. 19, the information about the cart area is configured by “type” and “Content_id”. For example, “type” denotes the content of an album if “type”=0 and denotes the content of an image if “type”=1, thereby denoting the type of the content in the cart area. “Content_id” denotes the ID of that content.

Namely, by acquiring this information about the cart area, the sale server 4 can share the information about the cart area corresponding to the user terminal 11 with the image service providing server 2.

Receiving the information (FIG. 9) about the cart area corresponding to the cart area ID via the network 1, the information acquisition library 223 of the sale server 4 determines in step S253 whether or not the content ID is included in the information about the cart area corresponding to the cart area ID. If, in step S253, the content ID is found included in the information about the cart area corresponding to the cart area ID, then the application server 212 executes the content information acquisition processing in step S254. The following describes this content information acquisition processing with reference to the flowchart shown in FIG. 15.

In step S271, the application server 212 controls the information request library 224 to request the acquisition of the content information corresponding to the content ID. At the same time, application server 212 controls the information request library 224 to request the deletion of the cart area corresponding to this cart area ID after the acquisition of the content information.

In response, the image service providing server 2 sends back the content information as shown in FIG. 20 corresponding to the received content ID (step S285 shown in FIG. 16).

Referring to FIG. 20, there is shown an exemplary configuration of content information corresponding to a content ID to be sent from the image service providing server 2 to the sale server 4. In the example shown in FIG. 20, the URL for referencing a thumbnail of content is shown in “URL1”, the URL for referencing a screennail of content is shown in “URL2”, the URL for referencing original content (simply referred to as content) is shown in “URL3”. A content title is shown in “Title”, a file name of content data is shown in “Filename”, a data size of content is shown in “Size”, and a MIME type of content data is shown in “MIME”. It should be noted that the thumbnail denotes a list of content each shrunk for list display as shown in FIG. 17, the screennail denotes the content shrunk for single display (to the size of screen for example), and the original content denotes the content of actual size.

In step S272, the information acquisition library 223 of the sale server 4 receives the content information (FIG. 20) corresponding to the content ID via the network 1 and supplies the received content information to the application server 212. In step S273, the application server 212 sends the received content information and the cart confirmation screen information created on the basis of the information stored in the database 214 to the user terminal 11 via the network 1 by controlling the sending block 222 of the Web server 211.

To be more specific, in the cart confirmation screen 331 described above with reference to FIG. 18, the shopping cart board 341, the title 342, the OK button 343, and the cancel button 344 are stored in the database 214 of the sale server 4, these reference the database 214. However, the thumbnail 314 references the storage 22 of the image service providing server 2 on the basis of the content information (for example, “URL1” for referencing content thumbnails) acquired from the image service providing server 2. Namely, in the sale server 4, the thumbnails or screennails of the content other than the content to be used in an actual sale service (for example, a content printing service) all reference the image service providing server 2 through the URL. Therefore, the sale server 4 provides services to the user terminal 11 by referencing the thumbnail and screennail of the content provided by the image service providing server 2 via the EJB container 102, the SOAP server 111, and the Web server 13 of the image service providing server 2 and the network 1.

Thus, the content provided by the image service providing server 2 need not be managed in the sale server 4, thereby lowering the management cost.

Having checked this cart confirmation screen, the user sends an instruction for purchasing a sale service based on the content indicated by the thumbnail 314 (step S234 shown in FIG. 13). The receiving block 221 of the Web server 211 receives this instruction from the user terminal 11, so that, in step S255 shown in FIG. 14, the application server 212 determines whether or not the user of the user terminal 11 performs sale service purchase. If, in step S255, the user of the user terminal 11 is found to perform sale service purchase, then, in step S256, the application server 212 controls the sending block 222 to send the purchase processing screen information necessary for the purchase of the sale service based on the content indicated by the thumbnail 314 to the user terminal 11.

The user terminal 11 sends the information necessary for purchase entered by the user via the network 1 (step S236 shown in FIG. 13). In response, the receiving block 221 of the Web server 211 receives this information necessary for purchase and supplies it to the application server 212. In step S257, the application server 212 determines whether or not the purchase processing of the user terminal 11 has been completed. If the purchase processing of the user terminal 11 is found completed, the application server 212 control the information request library 224 to send the request for the content corresponding to the content ID of thumbnail 314 selected by the user terminal 11 to the image service providing server 2 via the network 1 in step S258.

If the purchase processing of the user terminal 11 is found not completed in step S257, then the procedure returns to step S256 to repeat the above-mentioned processing therefrom.

The image service providing server 2 sends the content corresponding to the content ID. So, in step S259, the information acquisition library 223 gets the content corresponding to the content ID of the thumbnail 314 from the image service providing server 2.

On the other hand, if the authentication permission ticket and the cart area ID are found not received in step S251 or if no content ID is found included in the information about the cart area corresponding to the cart area ID in step S253, then the application server 212 controls the Web server 211 to send message screen information indicative of an error to the user terminal 11 via the network 1 in step S260 and send the URL of the image service providing server 2 to the user terminal 11 via the network 1 in step S261. Consequently, the user terminal 11 is redirected to the image service providing server 2.

If the user of the user terminal 11 is found not to perform sale service purchase in step S255, then the service providing processing of the sale server 4 comes to an end.

Thus, in the sale server 4, the sale service of the content data selected by the user of the user terminal 11 is provided. The following describes the content information sending processing of the image service providing server 2 corresponding to the service providing processing of the sale server 4 with reference to the flowchart shown in FIG. 16.

The SOAP receiving block 201 of the image service providing server 2 is kept in the standby state until the information about a cart area is requested by the sale server 4. If the request (step S252 shown in FIG. 14) for cart area information is found received from the sale server 4 in step S281, then the SOAP receiving block 201 gets the cart area information (FIG. 19) from the memory 23 on the basis of the cart area ID supplied from the sale server 4 and controls the SOAP sending block 202 to send it to the sale server 4 via the Web server 13 and the network 1.

The content information corresponding to the content ID and a request for deleting the cart area are sent from the sale server 4 (step S271 shown in FIG. 15). The SOAP receiving block 201 of the image service providing server 2 receives this request and supplies it to the EJB container 102. In step S283, the EJB container 102 determines whether or not the content information corresponding to the content ID and the request for deleting the cart area have been received.

If the content information and the cart area deletion request are found received in step S283, then, in step S284, the EJB container 102 searches the database 21 on the basis of the content ID supplied from the SOAP receiving block 201 for the content information (FIG. 20) corresponding to the content ID. In step S285, the EJB container 102 controls the SOAP sending block 202 to send the obtained content information to the sale server 4 via the Web server 13 and the network 1. In step S286, the SOAP receiving block 201 deletes the cart area in the memory 23 on the basis of the cart area ID requested in step S283.

Then, a request for the content corresponding to the content ID is sent (step S258 shown in FIG. 14) from the sale server 4. The SOAP receiving block 201 of the image service providing server 2 receives this request and supplies it to the EJB container 102. In step S287, the EJB container 102 determines whether or not the content request has been received. If the content request is found received, then, in step S288, the EJB container 102 gets the content from the storage 22 on the basis of the content ID received at the SOAP receiving block 201 and controls the SOAP sending block 202 to send the obtained content to the sale server 4 via the Web server 13 and the network 1.

On the other hand, if the content information and the cart area deletion request are found not received in step S283 or the content data request is found not received in step S287, then this processing comes to an end.

Thus, in the image service providing system, all accesses from the user terminal 11 are received by the image service providing server 2, so that the same content providing services may be provided for all user terminals 11. In addition, the same interface is used between the image service providing server 2 and all the sale servers 4, so that the common services of the image service providing system may be installed and managed and operated in a concentrated manner. This concentrated management and operation of the common services significantly lowers the management and operation costs of the image service providing system.

Further, the sale services based on the content of the image service providing system are executed by the sale server 4 corresponding to the area information of each user terminal 11, so that the load of the processing by the image service providing server 2 may be significantly mitigated. Still further, the sale server 4 is installed in each area, so that the sale services suitable for that area may be executed in addition to the above-mentioned same content providing services. Yet further, the content (content, thumbnails, screennails, and so on) to be provided is managed by the image service providing server 2 in a concentrated manner and therefore the content need not be managed by the sale server 4, thereby significantly reducing the management cost. It should be noted that this sale server 4 may be not only a server dedicated to the image service providing system but also a server of a business partner for example by arranging the same interface as that of the sale server 4.

It should be note that, in the above description, the communication between the user terminal 11 and the image service providing server 2 is executed by the session library 41 of the user terminal 11 and the SOAP server 111 of the image service providing server 2; alternatively, the communication between the user terminal 11 and the image service providing server 2 may be executed by the Web browser 40 of the user terminal 11 and the Web container 112 of the image service providing server 2 instead of the session library 41 of the user terminal 11 and the SOAP server 111 of the image service providing server 2.

Likewise, in the above description, the communication between the user terminal 11 and the sale server 4 is executed by the session library 41 of the user terminal 11 and the Web server 211 of the sale server 4; alternatively, the communication between the user terminal 11 and the sale server 4 may be executed by the Web browser 40 instead of the session library 41 of the user terminal 11, and the Web server 211 of the sale server 4.

The above-mentioned sequence of processing operations may be executed not only by hardware but also by software. In the software approach, the programs constituting the software are installed from a program storage medium into a computer incorporated in a dedicated hardware apparatus or a general-purpose personal computer for example which is able to execute various functions by installing various programs.

The recording media storing the above-mentioned software programs which are installed in a computer and made executable thereby may be constituted by a package medium made up of magnetic disk 51, 71 (including flexible disks), optical disk 52, 72 (including CD-ROM (Compact Disk-Read Only Memory) and DVD (Digital Versatile Disk), magneto-optical disk 53, 73 (including MD (Mini-Disc) (trademark)), or semiconductor memory 54, 74 or the ROM 32, 62, or storage block 38, 68 in which the programs are stored temporarily or permanently.

It should be noted herein that the steps for describing each program recorded in recording media include not only the processing operations which are sequentially executed in a time-dependent manner but also the processing operations which are executed concurrently or discretely.

It should be noted that the term system as used herein denotes an entire apparatus constituted by a plurality of apparatuses.

As described and according to the invention, a system with the service cores integrated may be constructed. Further, according to the invention, the load of processing may be mitigated, thereby significantly lowering the management and operation costs. Still further, according to the invention, user-friendliness may be significantly enhanced.

While preferred embodiments of the present invention have been described using specific terms, such description is for illustrative purposes only, and it is to be understood that changes and variations may be made without departing from the spirit or scope of the following claims.

What is claimed is:

1. An information processing system comprising:
a first information processing apparatus;
a second information processing apparatus, installed in each of areas, for authenticating said first information processing apparatus in a target area; and
a third information processing apparatus for providing content to said first information processing apparatus;
said first information apparatus, said second information apparatus, and said third information processing apparatus being interconnected via a network;
wherein said first information processing apparatus sends authentication information for authenticating a user and preset area information to said third information processing apparatus via said network;
said third information processing apparatus selects said second information processing apparatus corresponding to said area information obtained from said first information processing apparatus and sends said authentication information obtained from said first information processing apparatus to said selected second information processing apparatus via said network; and
said second information processing apparatus authenticates said first information processing apparatus on the basis of said authentication information received from said third information processing apparatus and sends authentication result information for said first information processing apparatus to said third information processing apparatus via said network.

2. The information processing system according to claim 1, wherein, if said third information processing apparatus determines that the authentication for said first information processing apparatus is permitted by said second information processing apparatus on the basis of said authentication result information supplied from said second information processing apparatus, said third information processing apparatus receives user information for said first information processing apparatus from said second information processing apparatus via said network.

3. The information processing system according to claim 1, wherein said third information processing apparatus transfers each piece of information with said second information processing apparatus in each area by use of a common library.

4. The information processing system according to claim 1, wherein said second information processing apparatus transfers each piece of information with said third information processing apparatus by use of a common interface in each area.

5. An information processing apparatus comprising:
acquiring means for acquiring authentication information for authenticating a user of first another information processing apparatus and preset area information from said first another information processing apparatus;
selecting means for selecting second another information processing apparatus corresponding to said area information acquired by said acquiring means;
sending means for sending, via said network, said authentication information of said first another information processing apparatus acquired by said acquiring means to said second another information processing apparatus selected by said selecting means; and
receiving means for receiving, via said network, authentication result information for said first another information processing apparatus from said second another information processing apparatus.

6. The information processing apparatus according to claim 5, further comprising:
determining means for determining whether or not authentication for said first another information processing apparatus has been permitted by said second another information processing apparatus on the basis of said authentication result information received by said receiving means;
wherein, if said authentication for said first another information processing apparatus is determined by said determining means to be permitted by said second another information processing apparatus, said receiving means receives user information corresponding to said first another information processing apparatus from said second another information processing apparatus via said network.

7. The information processing apparatus according to claim 5, wherein said area information is a language code and a country code.

8. The information processing apparatus according to claim 5, wherein said sending means and said receiving means are each configured by a library common to said second another information processing apparatus in each area.

9. An information processing method for an information processing apparatus for providing content, comprising the steps of:
acquiring authentication information for authenticating a user of first another information processing apparatus and preset area information from said first another information processing apparatus;
selecting second another information processing apparatus corresponding to said area information acquired by said acquiring step;
sending, via said network, said authentication information of said first another information processing apparatus acquired by said acquiring step to said second another information processing apparatus selected by said selecting step; and
receiving, via said network, authentication result information for said first another information processing apparatus from said second another information processing apparatus.

10. An information processing apparatus comprising:
receiving means for receiving, via a network, authentication information for authenticating a user of first another information processing apparatus from second another information processing apparatus;
authenticating means for authenticating said first another information processing apparatus on the basis of said authentication information received by said receiving means; and
sending means for sending, via said network, authentication result information for said first another information processing apparatus obtained by said authenticating means to said second another information processing apparatus.

11. The information processing apparatus according to claim 10, wherein said receiving means receives information about a request for user information corresponding to said first another information processing apparatus from said second another information processing apparatus; and
said sending means sends said user information corresponding to said first another information apparatus to said second another information processing apparatus on the basis of the request information received by said receiving means.

12. The information processing apparatus according to claim 11, wherein said sending means and said receiving means are each configured by an interface common to all areas.

13. An information processing method for an information processing apparatus installed in each area, comprising the steps of:
receiving, via a network, authentication information for authenticating a user of first another information processing apparatus from second another information processing apparatus;
authenticating said first another information processing apparatus on the basis of said authentication information received by said receiving step; and
sending, via said network, authentication result information for said first another information processing apparatus obtained by said authenticating step to said second another information processing apparatus.

14. An information processing apparatus comprising:
memory area control means for controlling the creation of a memory area corresponding to first another information processing apparatus accessed via a network;
storage means for receiving a content ID from said first another information processing apparatus and storing said content ID into said memory area whose creation has been controlled by said memory area control means;
issuing means for issuing a memory area ID of said memory area in which said content ID is stored and authentication permission information indicative of the authentication of said first another information processing apparatus;
selecting means for selecting second another information processing apparatus corresponding to said first another information processing apparatus on the basis of area information of said first another information processing apparatus; and
sending means for sending, via said network, said memory area ID and said authentication permission information issued by said issuing means to said first another information processing apparatus along with URL information of said second another information processing apparatus selected by said selecting means.

15. The information processing apparatus according to claim 14, wherein, in response to a request for information of said memory area corresponding to said memory area ID received from said second another information processing apparatus, said sending means sends said content ID from said memory area to said second another information processing apparatus via said network;
in response to a request for content information corresponding to said content ID received from said second another information processing apparatus, said sending means sends said content information to said second another information processing apparatus via said network; and
in response to said request for content corresponding to said content ID received from said second another information processing apparatus, said sending means sends said content to said second another information processing apparatus via said network.

16. The information processing apparatus according to claim 14, wherein said sending means is configured by an interface common to said second another information processing apparatus in each area.

17. The information processing apparatus according to claim 14, wherein, if said content ID received from said first another information processing apparatus has not been stored in said memory area by said storage means or if the deletion of said memory area corresponding to said memory ID has been requested by said second another information processing apparatus, said memory area control means controls the deletion of said memory area corresponding to said first another information processing apparatus.

18. An information processing method comprising the steps of:
controlling the creation of a memory area corresponding to first another information processing apparatus accessed via a network;
receiving a content ID from said first another information processing apparatus and storing said content ID into said memory area whose creation has been controlled by said memory area control step;
issuing a memory area ID of said memory area in which said content ID sent from said first another information processing apparatus is stored and authentication permission information indicative of the authentication of said first another information processing apparatus;
selecting second another information processing apparatus corresponding to said first another information processing apparatus on the basis of area information of said first another information processing apparatus; and
sending, via said network, said memory area ID and said authentication permission information issued by said issuing step to said first another information processing apparatus along with URL information of said second another information processing apparatus selected by said selecting step.

19. An information processing apparatus comprising:
receiving means for receiving, from first another information processing apparatus, via a network, a memory area ID corresponding to said first another information processing apparatus in second another information processing apparatus and authentication permission information indicative of being authenticated by said second another information processing apparatus;
acquiring means for acquiring, on the basis of said memory area ID and said authentication permission information received by said receiving means, a content ID stored in a memory area corresponding to said memory area ID and content information corresponding to said content ID from said second another information processing apparatus via said network; and
sending means for sending said content information acquired by said acquiring means to said first another information processing apparatus.

20. The information processing apparatus according to claim 19, further comprising:
determining means for determining, when said receiving means has received an instruction for purchasing a sale service of said content ID from said first another information processing apparatus, whether or not said instruction for purchasing said sale service corresponding to said content ID has been received by said receiving means;
wherein, if said instruction for purchasing said sale service corresponding to said content ID is found received by said determining means, said acquiring means acquires said content corresponding to said content ID from said second another information processing apparatus via said network.
